(19) United States
(12) Patent Application Publication
(10) Pub. No.: US 2025/0042124 A1
(43) Pub. Date: Feb. 6, 2025

(54) REINFORCED VOID FILLER

(71) Applicant: Signode Industrial Group LLC, Tampa, FL (US)

(72) Inventor: Randolph Lloyd Gray, Stockton, CA (US)

(21) Appl. No.: 18/767,487

(22) Filed: Jul. 9, 2024

Related U.S. Application Data
(60) Provisional application No. 63/517,006, filed on Aug. 1, 2023.

(51) Int. Cl. B32B 3/12; B32B 7/03; B32B 29/00; B32B 29/08

(52) U.S. Cl. CPC B32B 3/12; B32B 7/03; B32B 29/005; B32B 29/08

(57) ABSTRACT

Various embodiments of the present disclosure provide a reinforced void filler including a first panel; a first core attached to the first panel, the first core comprising multiple first cells; a second core attached to the first panel and spaced-apart from the first core in a width direction, the second core comprising multiple second cells; a first reinforcing member in one of the first cells; and a second reinforcing member in one of the second cells. The reinforcing members add rigidity and crush strength to the first and second cores to better withstand forces exerted on the reinforced void filler by cargo during transit.

### PRIORITY

This application claims priority to and the benefit of U.S. Provisional Patent Application No. 63/517,006, filed Aug. 1, 2023, the entire contents of which is incorporated herein by reference.

### FIELD

The present disclosure relates to a void filler for securing cargo during transit.

### BACKGROUND

Void fillers are used to stabilize cargo in cargo containers. Specifically, void fillers (and occasionally other dunnage) are positioned in voids between cargo, such as palletized loads, as the cargo is loaded into a cargo container. The void fillers limit movement of the cargo during transit to prevent damage to the cargo.

### SUMMARY

Various embodiments of the present disclosure provide a reinforced void filler including a first panel; a first core attached to the first panel, the first core comprising multiple first cells; a second core attached to the first panel and spaced-apart from the first core in a width direction, the second core comprising multiple second cells; a first reinforcing member in one of the first cells; and a second reinforcing member in one of the second cells. The reinforcing members add rigidity and crush strength to the first and second cores to better withstand forces exerted on the reinforced void filler by cargo during transit.

### BRIEF DESCRIPTION OF THE FIGURES

FIG. 1A is a front perspective view of one example embodiment of the reinforced void filler of the present disclosure.

FIG. 1B is a front perspective view of the reinforced void filler of FIG. 1A positioned between two palletized loads.

FIG. 2 is front elevational view of the reinforced void filler of FIG. 1A with one of the panels removed.

FIG. 3 is a front elevational view of part of one of the cores of the reinforced void filler of FIG. 1A including a reinforcing member.

FIG. 4 is a front elevational view of the reinforcing member of FIG. 3.

### DETAILED DESCRIPTION

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as coupled, mounted, connected, etc., are not intended to be limited to direct mounting methods but should be interpreted broadly to include indirect and operably coupled, mounted, connected and like mounting methods. This specification is intended to be taken as a whole and interpreted in accordance with the principles of the present disclosure and as understood by one of ordinary skill in the art.

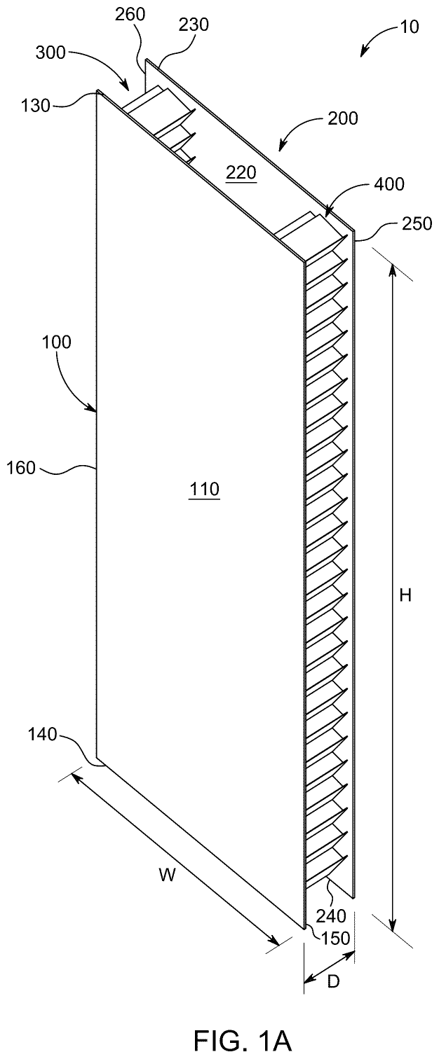

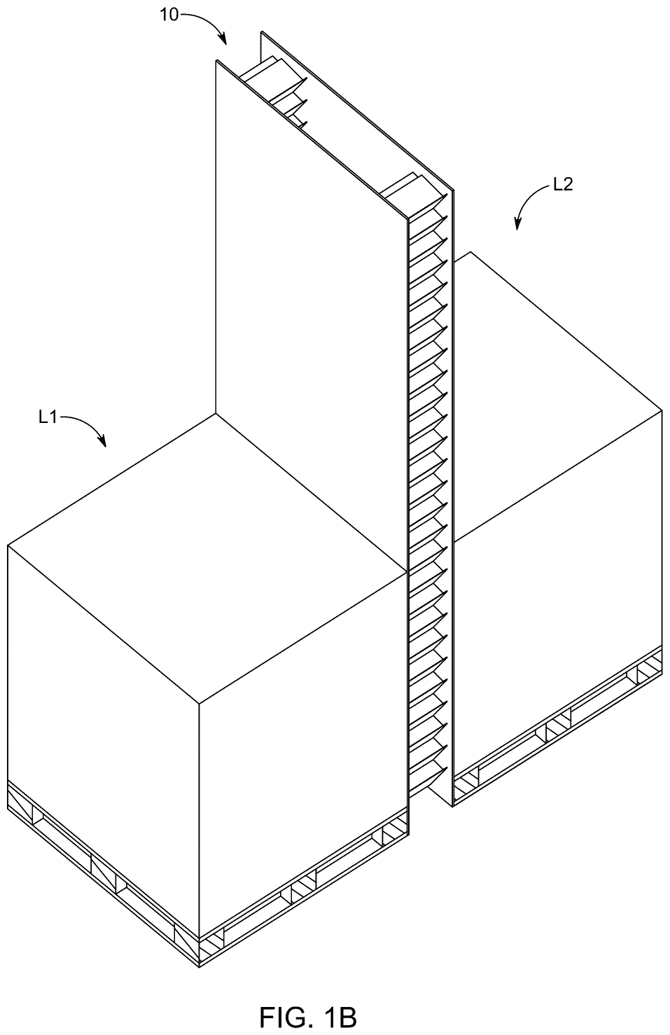

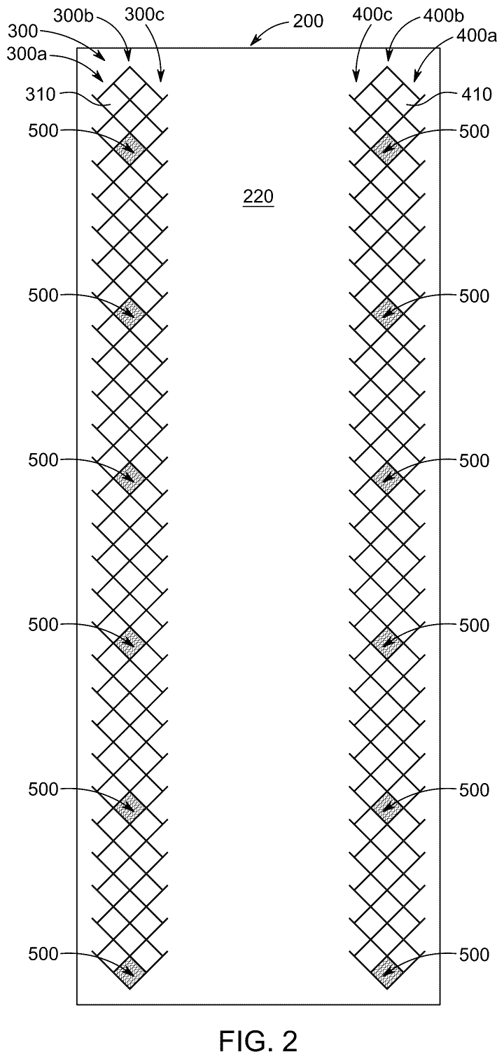

FIGS. 1A-4 show one example embodiment of a reinforced void filler 10 of the present disclosure. As shown in FIG. 1B, the reinforced void filler 10 is sized, shaped, and otherwise configured to be positioned in a void between cargo, such as first and second palletized loads L1 and L2 in a cargo container, to fill that void and limit movement of the cargo during transit. In this example embodiment, the reinforced void filler 10 is tall enough to fill the void between multiple pairs of palletized loads (not shown) stacked atop one another. The reinforced void filler 10 includes a first panel 100, a second panel 200, a first core 300, a second core 400, and multiple reinforcing members 500.

The first panel 100 includes a first face 110, a second face (not labeled) opposite the first face 110, a top edge 130, a bottom edge 140 opposite the top edge 130, a first side edge 150, and a second side edge 160 opposite the first side edge 150. The second panel 200 includes a first face (not labeled), a second face 220 opposite the first face, a top edge 230, a bottom edge 240 opposite the top edge 230, a first side edge 250, and a second side edge 260 opposite the first side edge 250. In this example embodiment, the first and second panels 100 and 200 are rectangular and formed from corrugated paperboard, though they may take any suitable shape and be formed from any suitable material in other embodiments. The first and second panels 100 and 200 are substantially the same size and together define a height H and width W of the reinforced void filler 10. In this example embodiment, the height H is approximately 96 inches and the width W is approximately 48 inches, though these values may differ in other embodiments.

The first and second cores 300 and 400 are connected to (such as via adhesive) and extend between the second faces of the first and second panels 100 and 200, respectively. The first and second cores 300 and 400 are formed from multiple plies of corrugated paperboard attached to one another and expanded to form multiple adjacent cells arranged in separate arrays between the first and second panels 100 and 200. In this example embodiment, the first core 300 includes first, second, and third columns 300a, 300b, and 300c of substantially identically shaped cells 310 that each have a generally diamond-shaped cross section. Similarly, the second core 400 includes first, second, and third columns 400a, 400b, and 400c of substantially identically shaped cells 410 that each have a generally diamond-shaped cross section. The cells may have any other suitably shaped cross-section (such as a hexagonal, circular, square, rectangular, or octagonal cross-section) in other embodiments. This is merely one example of the first and second cores 300 and 400, and any suitable cores may be employed.

The reinforced void filler 10 has a depth D largely defined by the depth of the cells of the first and second cores 300 and 400. In this example embodiment, the depth D is approximately 8 inches, though this value may differ in other embodiments. In this example embodiment, the first and second cores 300 and 400 extend substantially the entire height H of the void filler 10 but extend across less than half the width W of the void filler 10 such that the first and second cores 300 and 400 are spaced-apart in the width direction. The first and second cores are identical in this example embodiment, though may differ in other embodiments.

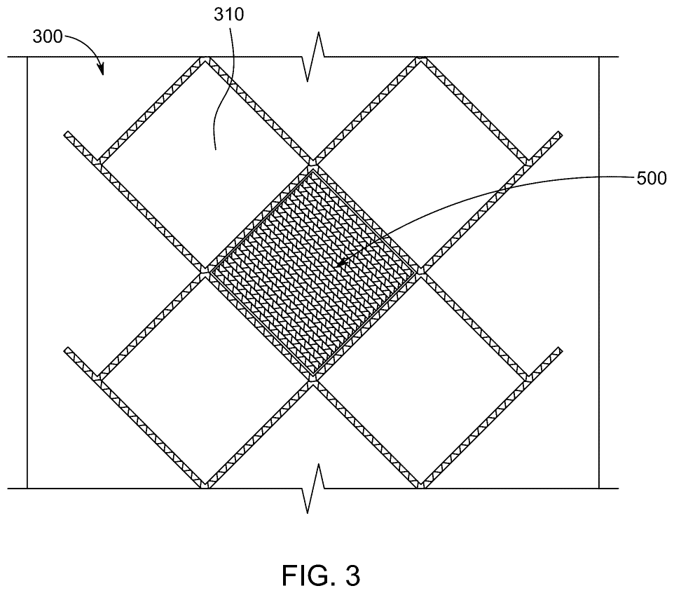

As best shown in FIG. 3, some, but not all, of the cells 310 and 410 of the first and second cores 300 and 400 are substantially filled by individual reinforcing members 500. The reinforcing members 500 add rigidity and crush strength to the first and second cores 300 and 400 of the reinforced void filler 10 in the depth direction to better withstand forces exerted on the reinforced void filler 10 by the cargo during transit. In this example embodiment, when a cell includes a reinforcing member, the reinforcing member is sized to fill at least 85% of the cell by volume. This percentage may differ in other embodiments. For instance, in various embodiments, when a cell includes a reinforcing member, the reinforcing member is sized to fill at least 50%, at least 75%, or at least 90% of the cell by volume. In this example embodiment, the reinforced void filler weighs about 14 pounds, though the weight may differ in other embodiments. In certain embodiments, certain partial cells at the sides of the cores are substantially filled by reinforcing members 500.

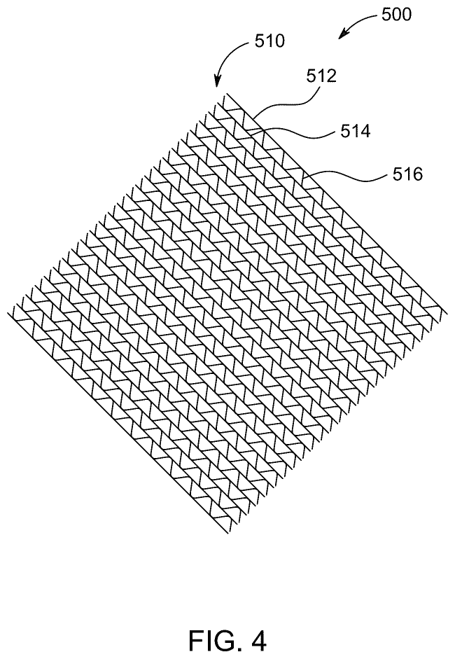

In this example embodiment, as best shown in FIG. 4, the reinforcing member 500 is formed from corrugated material, and in particular, multiple single-wall corrugated panels 510 attached to one another, such as via adhesive. Each corrugated panel 510 includes opposing first and second facing components 512 and 514 separated by and attached to (such as via adhesive) a fluted component 516. The first and second facing components 512 and 514 are substantially planar, while the fluted component 516 has a fluted (or wavy) profile, such as an A-Flute, B-Flute, C-Flute, E-Flute, or F-Flute profile, that forms multiple flutes. In this example embodiment, the first and second facing components and the fluted component are formed from kraft paper, though they may be formed from any other suitable material in other embodiments. In this example embodiment, the corrugated panels 510 of a reinforcing member 500 are oriented such that the flutes of each corrugated panel extend in the same direction, though they may be oriented differently in other embodiments. Additionally, in this example embodiment, the reinforcing members 500 are oriented such that each flute extends in depth direction of the reinforced void filler 10. Put differently, the flutes of the corrugated panels 510 of the reinforcing members 500 extend between and transverse to—and in this example embodiment, substantially perpendicular to—the first and second panels 100 and 200. The reinforcing members may be oriented differently in other embodiments.

In other embodiments, the reinforcing members are formed from alternating layers of facing components and fluted components attached to one another to form a multi-wall corrugated structure. In further embodiments, the reinforcing members are formed from multi-wall corrugated panels-such as dual-wall or triple-wall corrugated panels-attached to one another via adhesive or in any other similar manner.

In this example embodiment, the entire reinforced void filler is recyclable via the same recycling process, though they may not be the case in other embodiments. In this example embodiment, the panels, the cores, and the reinforcing members are formed from the same material—kraft paper—and attached via adhesive, though that may not be the case in other embodiments.

In this example embodiment, fewer than all of the cells 310 and 410 of the first and second cores 300 and 400 include a reinforcing member 500. Here, five of the cells 310 of the second column of cells 300b of the first core 300 and five of the cells 410 of the second column of cells 400b of the second core 400 include a reinforcing member 500. This amounts to fewer than 10% of the cells of each core including a reinforcing member, though this percentage may differ in other embodiments. In this example embodiment, adjacent cells including reinforcing members are spaced apart substantially equally in the height direction. Any suitable quantity of the cells of the cores of the reinforced void filler may include a reinforcing member in other embodiments.

1. A reinforced void filler comprising:
a first panel;
a first core attached to the first panel, the first core comprising a first quantity of first cells;
a second core attached to the first panel, the second core comprising a second quantity of second cells;
a third quantity of first reinforcing members, wherein each of the first reinforcing members is positioned in a different one of the first cells, wherein the first quantity is greater than the third quantity; and
a fourth quantity of second reinforcing members, wherein each of the second reinforcing members is positioned in a different one of the second cells, wherein the second quantity is greater than the third quantity.

2. The reinforced void filler of claim 1, wherein the first and second reinforcing members are each formed from corrugated material.

3. The reinforced void filler of claim 2, wherein the corrugated material comprises flutes.

4. The reinforced void filler of claim 3, wherein each first and second reinforcing member is oriented such that the flutes extend transverse to the first panel.

5. The reinforced void filler of claim 4, further comprising a second panel, wherein the first and second cores are attached to the second panel such that the first and second cores are positioned between the first and second panels.

6. The reinforced void filler of claim 5, wherein each first and second reinforcing member is oriented such that the flutes extend transverse to the first and second panels.

7. The reinforced void filler of claim 4, wherein each of the first and second reinforcing members is formed from alternating layers of facing components and fluted components attached to one another.

8. The reinforced void filler of claim 7, wherein the facing components and the fluted components are formed from kraft paper.

9. The reinforced void filler of claim 4, wherein each first and second reinforcing member is formed from multiple single-wall corrugated panels attached to one another, wherein each single-wall corrugated panel includes a pair of facing components separated by a fluting component.

10. The reinforced void filler of claim 1, wherein each first reinforcing member fills at least 50% of the first cell including that first reinforcing member by volume, wherein each second reinforcing member fills at least 50% of the second cell including that second reinforcing member by volume.

11. The reinforced void filler of claim 10, wherein each first and second reinforcing member is formed from corrugated material, wherein the corrugated material comprises flutes, wherein each first and second reinforcing member is oriented such that the flutes extend transverse to the first panel.

12. The reinforced void filler of claim 10, wherein the third quantity is no more than 20% of the first quantity, wherein the fourth quantity is no more than 20% of the second quantity.

13. The reinforced void filler of claim 1, wherein the third and fourth quantities are each greater than one.

14. The reinforced void filler of claim 13, wherein each first reinforcing member fills at least 50% of the first cell including that first reinforcing member by volume, wherein each second reinforcing member fills at least 50% of the second cell including that second reinforcing member by volume.

15. The reinforced void filler of claim 14, wherein the first panel comprises opposing spaced-apart top and bottom edges and opposing spaced-apart first and second side edges extending between the top and bottom edges, wherein a first one of the first reinforcing members is closer to the top edge than the bottom edge, wherein a second one of the first reinforcing members is closer to the bottom edge than the top edge, wherein a third one of the first reinforcing members is between the top and bottom edges, wherein a first one of the second reinforcing members is closer to the top edge than the bottom edge, wherein a second one of the second reinforcing members is closer to the bottom edge than the top edge, wherein a third one of the second reinforcing members is between the top and bottom edges.

16. The reinforced void filler of claim 15, wherein each first and second reinforcing member is formed from corrugated material, wherein the corrugated material comprises flutes, wherein each first and second reinforcing member is oriented such that the flutes extend transverse to the first panel.

17. The reinforced void filler of claim 16, wherein adjacent first reinforcing members are separated by substantially the same distance in a height direction of the void filler.
